(19) United States
(12) Patent Application Publication
(10) Pub. No.: US 2008/0001899 A1
(43) Pub. Date: Jan. 3, 2008

(54) FLAT DISPLAY STRUCTURE

(75) Inventors: Chien-Ting Chan, Changhua County (TW); Yi-Cheng Tsai, Chiayi County (TW); Hsi-Rong Han, Taichung County (TW); Wen-Tui Liao, Taichung City (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: WINTEK CORPORATION, Taichung (TW)

(21) Appl. No.: 11/608,933

(22) Filed: Dec. 11, 2006

(30) Foreign Application Priority Data
Jul. 3, 2006 (TW) 95124207

(51) Int. Cl. G09G 3/36

(52) U.S. Cl. 345/100

(57) ABSTRACT

A flat display structure includes a substrate, a pixel array, a first-stage shift register and a second-stage shift register. The substrate includes a signal line. The pixel array is disposed on the substrate. The first-stage shift register is disposed at a first side of the pixel array and coupled to the signal line for outputting a first-stage scan signal to the pixel array according to trigger of a first start pulse. The second-stage shift register is disposed at a second side of the pixel array and coupled to the signal line for receiving a second start pulse via the signal line.

This application claims the benefit of Taiwan application Serial No. 95124207, filed Jul. 3, 2006, the subject matter of which is incorporated herein by reference.

### BACKGROUND OF THE INVENTION

1. Field of the Invention

The invention relates in general to a flat display structure, and more particularly to a flat display structure of dual-side panel driving.

2. Description of the Related Art

In a conventional single-side driving scan circuit, a shift register circuit is disposed at either side of a pixel array. However, under request of high resolution, the single-side driving design will increase panel size. Therefore, a dual-side driving circuit is generated to meet consumers' requirement for thin and small products.

FIG. 1A and FIG. 1B are block diagrams of a gate driving circuit disclosed in a US patent No. 20040217935. As shown in FIG. 1A, odd-stage shift registers SRC_O₁, SRC_O₂, . . . are disposed at one side of a pixel array (not shown in the figure) and respectively provide odd-stage scan signals GL₁, GL₃, . . . to drive odd rows of pixels. As shown in FIG. 1B, even-stage shift registers SRC_E₁, SRC_E₂, . . . are disposed at the other side of the pixel array and respectively provide even-stage scan signals GL₂, GL₄, . . . to drive even rows of pixels.

The shift register SRC_O₁ outputs the scan signal GL₁ according to a start pulse ST_0 and clock signal CK_0 provided by a control circuit (not shown in the figure) and the shift register SRC_E₁ outputs the scan signal GL₂ according to another start pulse ST_E and clock signal CK_E provided by the control circuit. Moreover, the shift registers SRC_O₂ and SRC_E₂ respectively use driving signals S1 and S2 outputted by the shift registers SRC_O₁ and SRC_E₁ as a start pulse and output the scan signals GL₃ and GL₄ according to clock signals CKB_0 and CKB_E. Owing that the shift registers SRC_O₁ and SRC_E₁ need to respectively use the start pulses ST_O and ST_E to generate the scan signals GL₁ and GL₂ and the whole shift register circuit has to use four clock signals CK_0, CK_E, CKB_0 and CKB_E, both of which will increase power consumption of the whole driving circuit.

### SUMMARY OF THE INVENTION

It is therefore an object of the invention to provide a flat display structure. A start pulse or output signal of the first-stage shift register is directly used as a start pulse for the second-stage shift register or only three clock signals are used to drive odd-stage or even-stage shift registers. Therefore, power consumption of the flat display can be effectively reduced.

The invention achieves the above-identified object by providing a flat display structure including a substrate, a pixel array, a first-stage shift register and a second-stage shift register. The substrate includes a signal line. The pixel array is disposed on the substrate. The first-stage shift register is disposed at a first side of the pixel array and coupled to the signal line for outputting a first-stage scan signal to the pixel array according to trigger of a first start pulse. The second-stage shift register is disposed at a second side of the pixel array and coupled to the signal line for receiving a second start pulse via the signal line.

The invention achieves the above-identified object by providing a flat display structure including a pixel array, a first-stage shift register and a second-stage shift register. The first-stage shift register is disposed at a first side of the pixel array for outputting a first-stage scan signal to the pixel array according to a first clock signal and a second clock signal. The second-stage shift register is disposed at a second side of the pixel array for outputting a second-stage scan signal to the pixel array according to the second clock signal and a third clock signal. In a first timing stage, the first clock signal has a first voltage level, and the second clock signal and the third clock signal both have a second voltage level. In a second timing stage, the first clock signal and the third clock signal both have the second voltage level and the second clock signal has the first voltage level. In a third timing stage, the first clock signal and the second clock signal both have the second voltage level and the third clock signal has the first voltage level.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A and FIG. 1B are block diagrams of a gate driving circuit disclosed in a US patent No. 20040217935.

FIG. 2 is a block diagram of a flat display structure according to the first embodiment of the invention.

FIG. 3 is a timing diagram of stimulation signals of the flat display 200 in FIG. 2.

FIG. 4 is a disposition diagram of the signal line for the second-stage shift register to receive the first-stage scan signal in the flat display structure according to the first embodiment of the invention.

FIG. 5 is a disposition diagram of the signal line for the second-stage shift register to receive the star pulse of the first-stage shift register in the flat display structure according to the first embodiment of the invention.

FIG. 6 is a block diagram of a flat display structure according to the second embodiment of the invention.

FIG. 7 is a structure diagram of the shift register circuit of the flat display in FIG. 6.

FIG. 8 is a timing diagram of stimulation signals for gate driving of the flat display in FIG. 6.

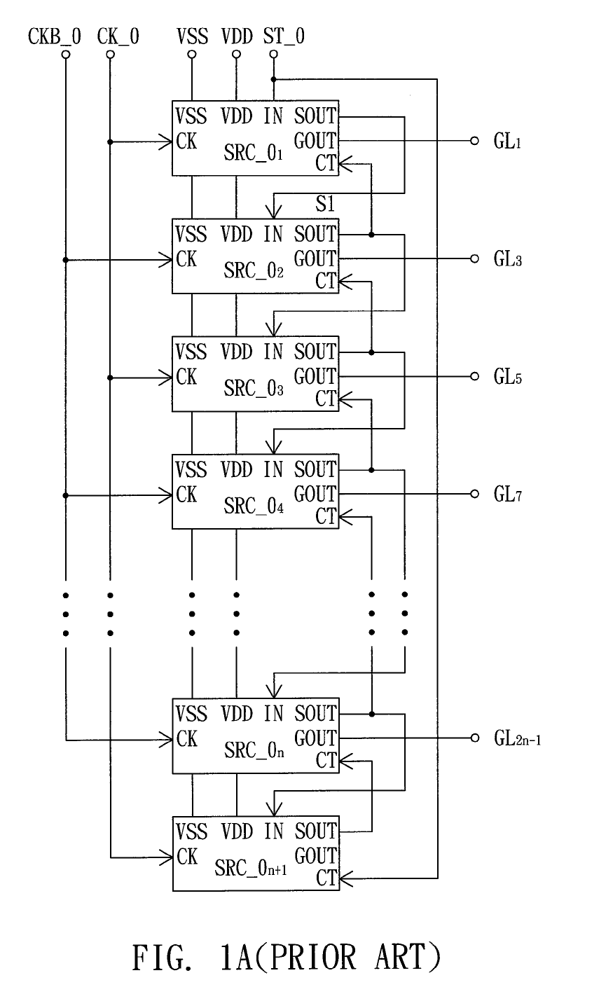

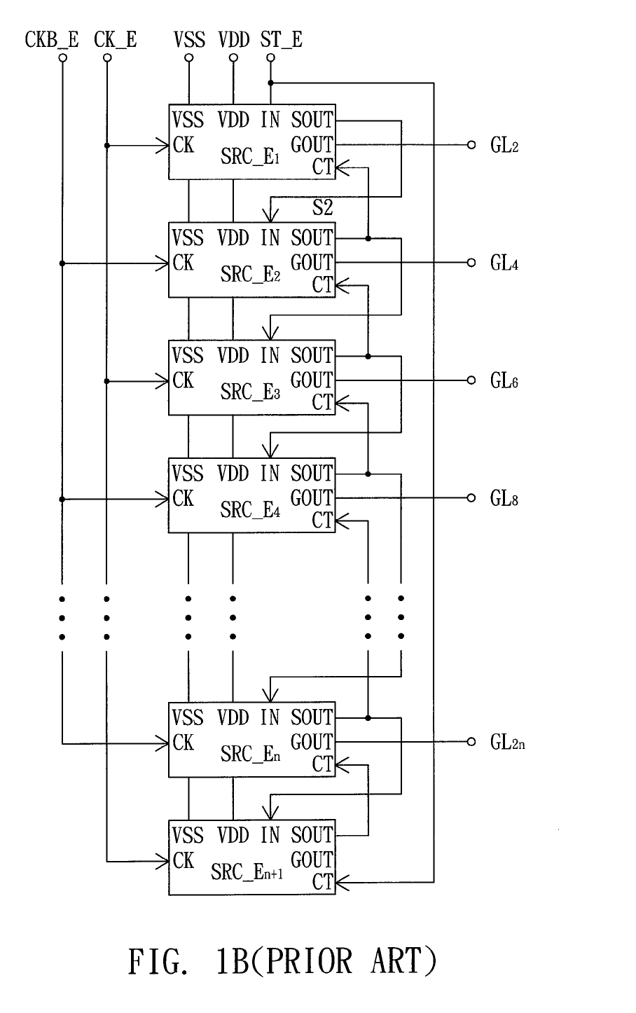

### DETAILED DESCRIPTION OF THE INVENTION

### Embodiment One

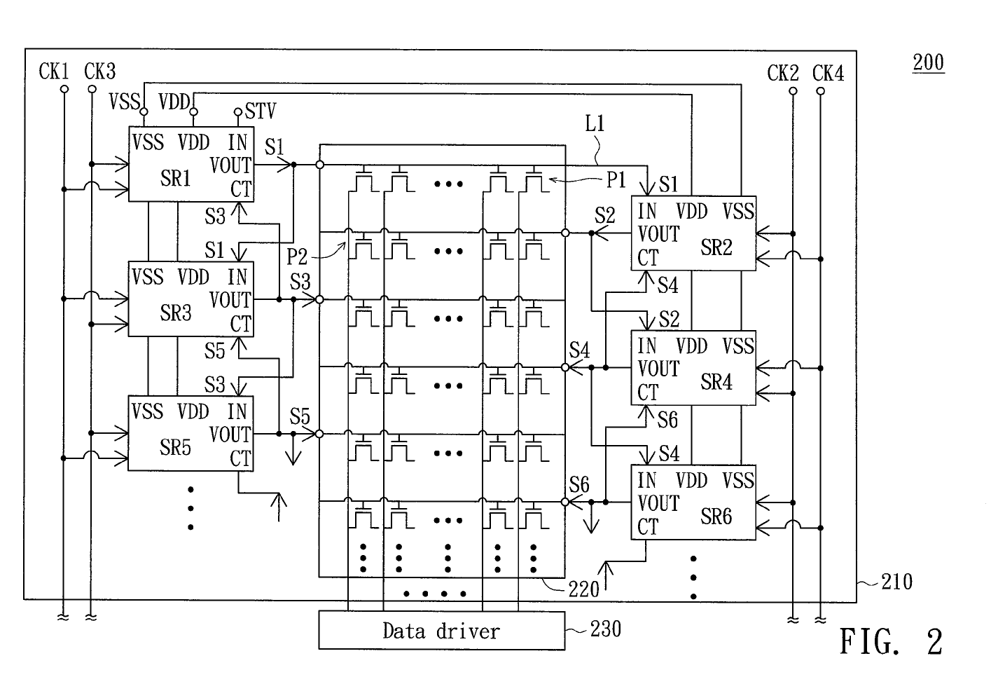

Referring to FIG. 2, a block diagram of a flat display structure according to the first embodiment of the invention is shown. A flat display 200, such as an amorphous silicone (a-Si) thin film transistor (TFT) liquid crystal display (LCD), has a structure including a substrate 210, a pixel array 220, several stages of shift registers and a data driver 230. The pixel array 220 is disposed on the substrate 210. The shift registers, such as disposed on the substrate 210, include odd-stage shift registers such as the first-stage shift register SR1, the third-stage shift register SR3, . . . and even-stage shift registers such as the second-stage shift register SR2, the four-stage shift register SR4, . . . . The odd-stage shift register SR1, SR3, . . . are disposed at a left side of the pixel array 220 and the even-stage shift registers SR2, SR4, . . . are disposed at a right side of the pixel array 220. All the shift registers use the same operational voltages VDD and VSS.

The first-stage shift register SR1 receives the third-stage scan signal S3 and outputs the first-stage scan signal S1 to enable the first row of pixels P1 in the pixel array 220 via a scan line L1 and receive data signals from the data driver 230 according to the first clock signal CK1 and the third clock signal CK3 after triggered by a start pulse STV. The second-stage shift register SR2 is coupled to the scan line L1 for receiving the first-stage scan signal S1 as a start pulse. The second-stage shift register SR2 receives the four-stage scan signal S4 and outputs the second-stage scan signal S2 to enable the second row of pixels P2 in the pixel array 220 via a scan line L2 and receive data signal D2 from the data driver 230 according to the second clock signal CK2 and the four clock signal CK4 after triggered by the first-stage scan signal S1 (a start pulse). Subsequently, the odd-stage shift registers SR3, respectively receive the next odd-stage scan signals S5, . . . and output the odd-stage scan signals S3, . . . to the pixel array 220 according to the first clock signal CK1 and the third clock signal CK3 after triggered by the previous odd-stage scan signals S1, . . . (start pulses). The even-stage shift registers SR4, respectively receive the next even-stage scan signals S6, . . . and output the even-stage scan signals S2, . . . to the pixel array 220 according to the second clock signal CK2 and the four clock signal CK4 after triggered by the previous even-stage scan signals S2, . . . (start pulses).

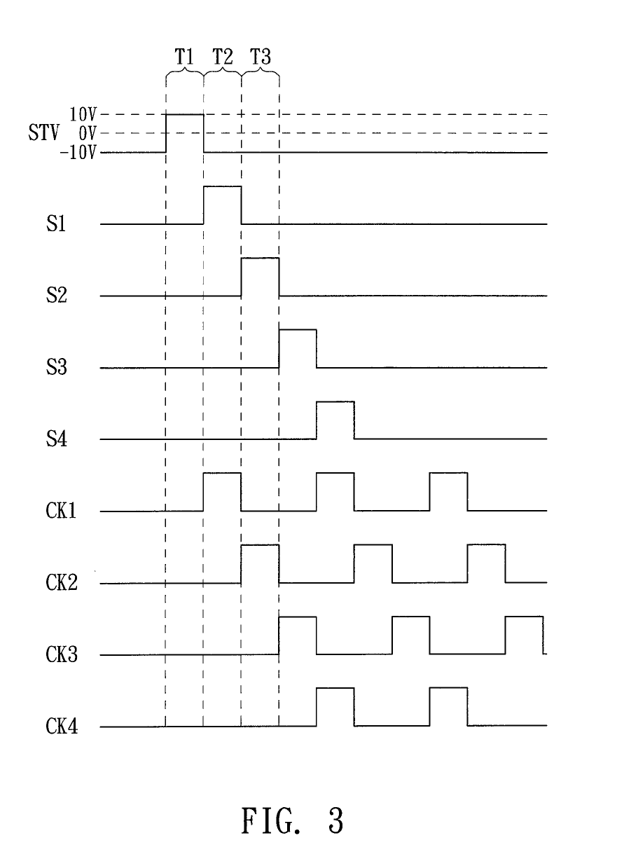

Referring to FIG. 3, a timing diagram of stimulation signals of the flat display 200 in FIG. 2 is shown. As shown in FIG. 3, in the timing stage T1, the start pulse STV is at a high voltage level, such as 10V. The first-stage shift register SR1 outputs the first-stage scan signal with a high voltage level (10V) to the pixel array 220 according to the first clock signal CK1 with a high voltage level after triggered by the start pulse STV in the second stage T2. Following that, the second-stage shift register SR2 outputs the second-stage scan signal with a high voltage level (10V) to the pixel array 220 according to the second clock signal CK2 with a high voltage level after triggered by the first-stage scan signal S1 in the timing stage T3. Analogized by the same reason, in the following timing, the shift registers SR3, SR4, . . . successively output scan signals S3, S4, . . . with a high voltage level (10V) to the pixel array 220 to achieve the purpose of dual-side panel driving.

As mentioned above, in the flat display of the embodiment, the second-stage shift register SR2 receives the first-stage scan signal S1 directly via the scan line L1 as a start pulse. Therefore, not only a normal operation of dual-side panel driving can be achieved, but also power consumption and cost for the driving circuit can be effectively reduced without need to provide another start pulse from a control circuit.

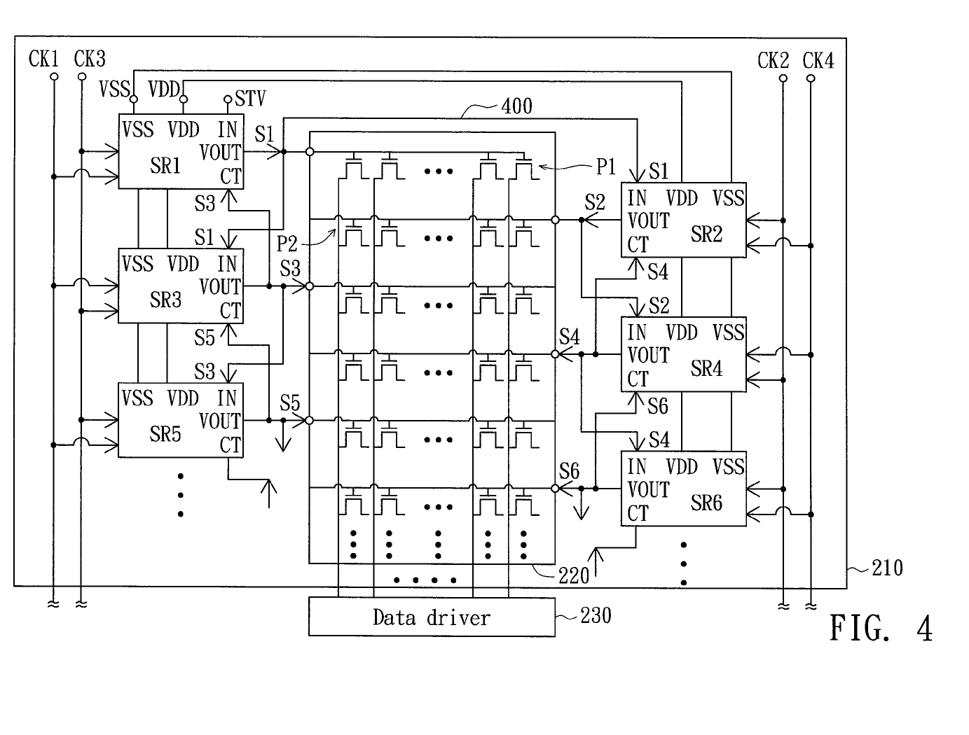

Although the second-stage shift register SR2 is exemplified to couple with the scan line L1 to receive the scan signal S1 as a start pulse in the invention, as shown in FIG. 4, the flat display structure of the invention can also include a signal line 400 disposed in a region of the substrate 210 outside the pixel array 220 and coupled to a scan-signal output terminal VOUT of the first-stage shift register SR1 and a start-pulse input terminal IN of the second-stage shift register SR2. The second-stage shift register SR2 receives the first-stage scan signal S1 as a start pulse via the signal line 400. By doing this, the signal delay generated as the scan signal S1 outputted by the first-stage shift register SR1 is transmitted from the left side the pixel array 220 to the second-stage shift register SR2 at the right side as a start pulse can be reduced.

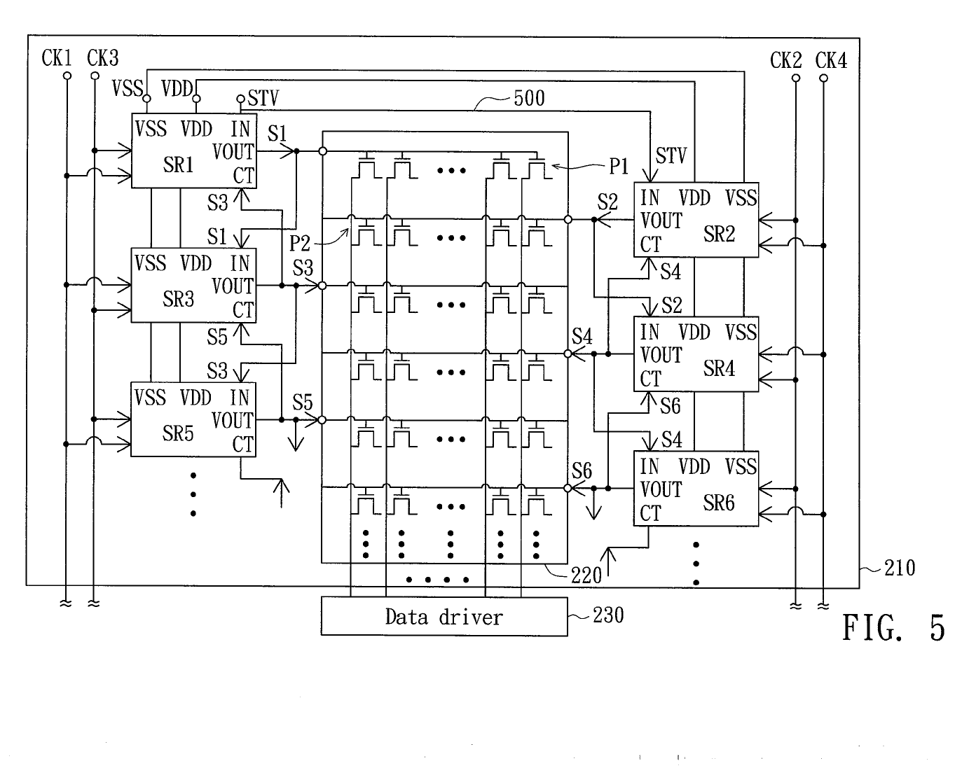

Or as shown in FIG. 5, the flat display structure of the invention can also include a signal line 500 disposed in a region of the substrate 210 outside the pixel array 220 and coupled to a start-pulse input terminal IN of the first-stage shift register SR1 and a start-pulse input terminal IN of the second-stage shift register SR2. The second-stage shift register SR2 directly uses the start pulse STV as its start pulse. As long as a signal line is disposed on the substrate and coupled to the first-stage shift register and the second-stage shift register such that the second-stage shift register can receive a related signal of the first-stage shift register as a start pulse via the signal line without need to use a start pulse provided by a control circuit, and thus the purpose of dual-side panel driving can be achieved, all these will not depart from the scope of the invention.

### Embodiment Two

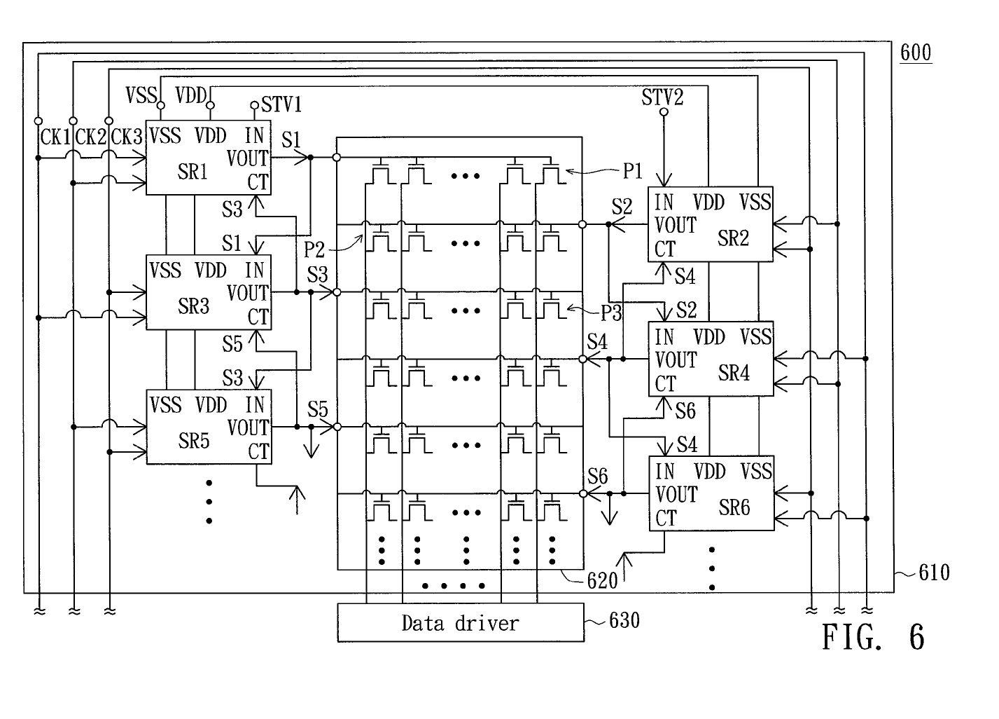

Referring to FIG. 6, a block diagram of a flat display structure according to the second embodiment of the invention is shown. A flat display 600, such as an a-Si TFT LCD, has a structure including a substrate 610, a pixel array 620, several stages of shift registers and a data driver 630. The pixel array 620 is disposed on the substrate 610. The shift registers, for example, are disposed on the substrate 610 and include odd-stage shift registers such as the first-stage shift register SR1, the third-stage shift register SR3, . . . and even-stage shift registers such as the second-stage shift register SR2, the four-stage shift register SR4, . . . . The odd-stage shift registers SR1, SR3, . . . are disposed at the left side of the pixel array 620 while the even-stage shift registers SR2, SR4, . . . are disposed at the right side of the pixel array 620.

The first-stage shift register SR1 receives a third-stage scan signal S3 and outputs a first-stage scan signal S1 to enable the first row of pixels P1 in the pixel array 620 to receive data signals from the data driver 630 according to the first clock signal CK1 and the second clock signal CK2 after triggered by the first start pulse STV1. The second-stage shift register SR2 receives a fourth-stage scan signal S4 and outputs a second-stage scan signal S2 to enable the second row of pixels P2 in the pixel array 620 to receive data signals from the data driver 630 according to the second clock signal CK2 and the third clock signal CK3 after triggered by the second start pulse STV2. The first start pulse STV1 and the second start pulse STV2 are, for example, provided by a control circuit (not shown in the figure).

Besides, the third-stage shift register SR3 receives the fifth-stage scan signal S5 and outputs the third-stage scan signal S3 to enable the third row of pixels P3 in the pixel array 620 to receive data signals from a data driver 630 according to the third clock signal CK3 and the first clock signal CK1 after triggered by the first-stage scan signal Si. Afterward, use every three shift registers as a circle, that is, the shift registers SR(i), SR(i+1) and SR(i+2) (i≧4) respectively receive the next-second-stage scan signals S(i+2), S(i+3) and S(i+4) and output scan signals S(i), S(i+1) and S(i+2) to the pixel array 620 according to the clock signals CK1 and CK2, CK2 and CK3, and CK3 and CK1 after triggered by the previous-second-stage scan signals S(i−2), S(i−1) and S(1) (as start pulses).

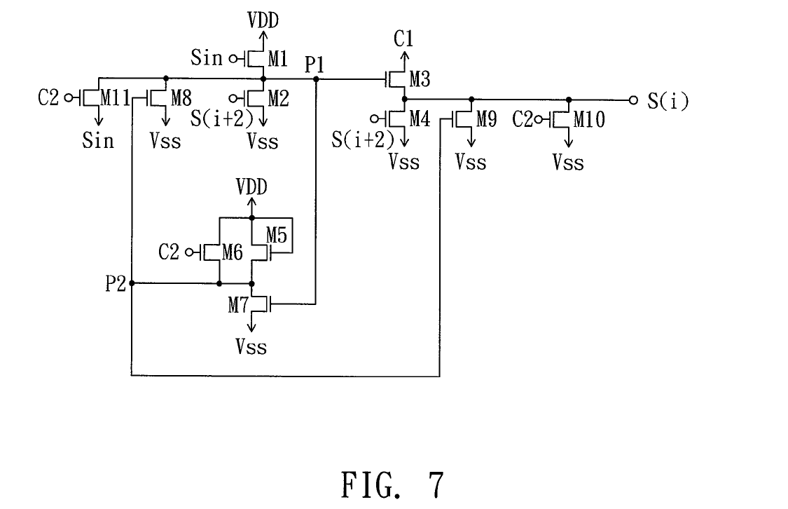

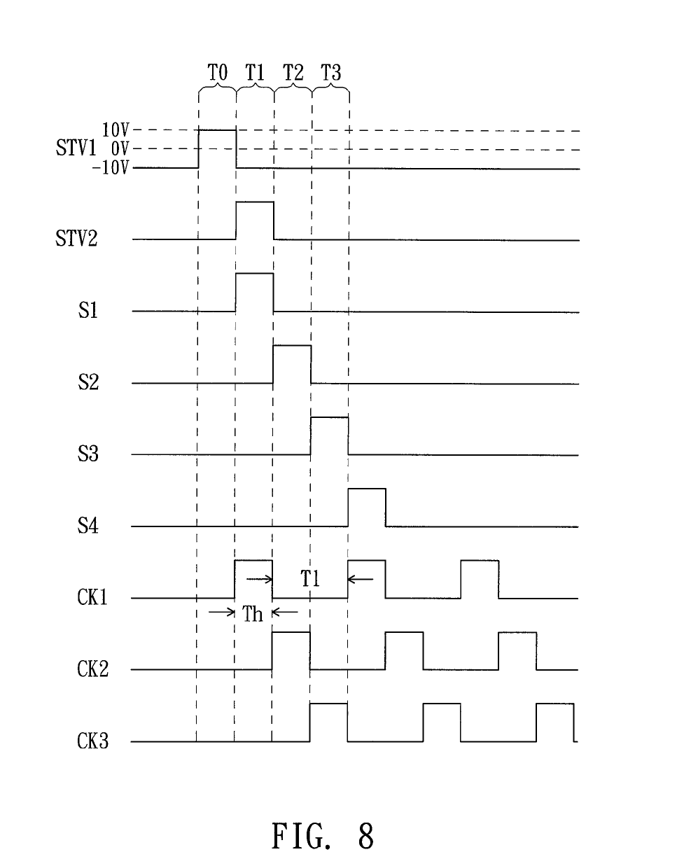

Referring to FIG. 7 and FIG. 8 simultaneously, a structure diagram of the shift register circuit and a timing diagram of stimulation signals for gate driving of the flat display 600 in FIG. 6 are respectively shown. As shown in FIG. 7, the above shift register SR(i) includes 11 N-type metal oxide semiconductor (NMOS) transistors M1˜M11. An input signal Sin is inputted to a gate of the transistor M1, coupled to a source of the transistor M11 and used as a start pulse of the shift register SR(i). Besides, gates of the transistors M2 and M4 are for receiving the next-second-stage scan signal S(i+2). The clock signal C1 (=CK1, CK2 or CK3) is coupled to a drain of the transistor M3 and the clock signal C2 (=CK2, CK3 or CK1) controls gates of the transistors M6, M10 and M11.

As shown in FIG. 8, the first clock signal CK1 includes a number of high-level timing intervals Th and low-level timing intervals TI which are generated successively. The low-level timing interval T1 is twice of the high-level timing interval Th. The second clock signal CK2 has a timing slower than the first clock signal CK1 by the high-level interval Th and the third clock signal CK3 has a timing slower than the second clock signal CK2 by the high-level timing interval Th.

In the initial timing stage T0, in terms of the first-stage (i=1) shift register SR1, the input signal Sin is the first start pulse STV1 which outputs a high voltage (such as 10V) and the scan signal S3 and the clock signals C1 (=CK1) and C2 (=CK2) all output a low voltage. Therefore, the transistors M1, M3, and M7 in the shift register SR1 are all turned on such that the voltage at the node P1 is at a high level and the transistors M4, M9 and M10 are turned off. At the time, the scan signal S1 is lowered down to a low level by the clock signal C1 (=CK1) with a low voltage.

Moreover, in terms of the second-stage (i=2) shift register, the input signal Sin is the second start pulse STV2 which outputs a low voltage, such as −10V, and the clock signals C1 (=CK2) and C2 (=CK3) are at a low voltage level. Therefore, the transistors M1˜M11 of the shift register SR2 are all turned off such that the scan signal S2 is at a low voltage level. Analogized by the same reason, in terms of the following shift registers SR3, . . . , the input signal Sin is the previous-second-stage scan signal S1, . . . which is at a low voltage level and the clock signals C1 and C2 are both at a low voltage level. Therefore, all the scan signals S3, . . . outputted by the shift registers SR3, . . . have the low voltage level.

Afterwards, in the first timing stage T1, in terms of the first-stage shift register SR1, the input signal Sin (=STV1) outputs a low voltage, the clock signal C1 is changed to a high voltage level, and the clock signal C2 (=CK2) is still at a low voltage level. At the time, the voltage at the node P1 is lifted up to a higher voltage level due to a bootstrap effect such that the transistor M3 of the shift register SR1 is turned on and the scan signal S1 outputs a perfect high voltage level of the clock signal C1 (=CK1).

In terms of the second-stage shift register SR2, the input signal Sin (=STV2) outputs a high voltage and the clock signals C1 (=CK2) and C2 (=CK3) are both at a low voltage level. Similar to the operation condition of the first-stage shift register SR1 in the above timing stage T0, the voltage at the node P1 in the second-stage shift register SR2 is at a high level and the scan signal S2 outputs a low voltage.

In terms of the third shift register SR3, the start pulse Sin is the scan signal S1 which outputs also a high voltage, the clock signal C1 (=Ck3) has a low voltage level and the clock signal C2 (=CK1) has a high voltage level. Therefore, the transistor M10 of the shift register SR3 is turned on to output the scan signal S3 with a low voltage level. Analogized by the same reason, it can be known that all the scan signals S4, . . . have a low voltage level.

Next, in the second timing stage T2, in terms of the first-stage shift register SR1, the input signal Sin (=STV1) has a low voltage level, the clock signal C1 (=CK1) has a low voltage level and the clock signal C2 (=CK2) has a high voltage level. At the time, the transistor M10 of the shift register SR1 is turned on such that the scan signal S1 outputs a low voltage.

In terms of the second-stage shift register SR2, the input signal Sin (=STV2) outputs a low voltage, the clock signal C1 (=CK2) has a high voltage level and the clock signal C2 (=CK3) has a low voltage level. Similar to operation condition of the first-stage shift register SR1 in the previous timing stage T1, the voltage of the node P1 in the shift register SR2 is still at a high level such that the transistor M3 of the shift register SR2 is turned on and the scan signal S2 outputs the high voltage level of the clock signal C1 (=CK2).

In terms of the third-stage shift register SR3, the start pulse Sin is the scan signal S1 and outputs a low voltage and the clock signals C1 (=CK3) and C2 (=CK1) both have a low voltage level. At the time, the transistor M3 of the shift register SR3 is turned on such that the scan signal S3 is the low-level clock signal C1. Analogized by the same reason, it can be known that the scan signals S4, all have a low voltage level.

Following that, in the third timing stage T3, in terms of the first-stage shift register SR1, the input signal Sin (=STV1) has a low voltage level, and the clock signals C1 (=CK1) and C2 (=CK2) both have a low voltage level. The third-stage scan signal S3 outputs a high voltage such that the transistor M2 of the shift register SR1 is turned on and the voltage at the node P1 is at a low level. As a result, the transistor M3 is turned off and the scan signal S1 outputs a low voltage.

In terms of the second-stage shift register SR2, the input signal Sin (=STV2) outputs a low voltage, the clock signal C1 (=CK2) has a low voltage level and the clock signal C2 (=CK3) has a high voltage level. Similar to operation condition of the first-stage shift register SR1 in the above timing stage T2, the transistor M10 of the shift register SR2 is turned on such that the scan signal S2 outputs a low voltage.

In terms of the third-stage shift register SR3, the start pulse Sin is the scan output S1 and outputs a low voltage, the clock signal C1 (=CK3) is at a high voltage level and the clock signal C2 (=CK1) has a low voltage level. Similar to operation condition of the second-stage shift register SR2 of the above timing stage T2, the voltage at the node P1 in the shift register SR3 is remained at a high level such that the transistor M3 of the shift register SR2 is turned on and the scan signal S2 outputs a high voltage of the clock signal C1 (=CK3). Analogized by the same reason, it can be known that the scan signals S4, are all at a low voltage level. Therefore, the shift register circuit of the flat display structure of the embodiment only needs three clock signals CK1˜CK3 to achieve the purpose of dual-side panel driving.

Although the first-stage shift register SR1 and the second-stage shift register SR2 are exemplified to respectively receive different start pulses STV1 and STV2 in the invention, the flat display structure of the invention can also include the second-stage shift register SR1 coupled to the scan line L1 for receiving the scan signal SI as a start pulse as shown in FIG. 2. Or as shown in FIG. 4, the second-stage shift register SR2 is coupled to a scan-signal output terminal VOUT of the shift register SR1 via a signal line disposed in a region of the substrate 210 outside the pixel array 220. Or as shown in FIG. 5, the second-stage shift register SR2 can also be coupled to a start-pulse input terminal IN of the first-stage shift register SR1 via a signal line 500 disposed in a region of the substrate 210 outside the pixel array 220 and directly used the start pulse STV as its start pulse. As long as three clock signals CK1˜CK3 are used to achieve the purpose of dual-side panel driving, all these will depart the scope of the invention.

The advantage of the flat display structure disclosed by the above two embodiments of the invention lies on the second-stage shift register directly uses the start pulse or the scan signal of the first-stage shift register as the required start pulse or the even-stage or odd-stage shift registers only need to use three clock signals to achieve the purpose of dual-side panel driving. Therefore, power consumption and cost of the driving circuit can be effectively reduced and market competitiveness of the flat display can be improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A flat display structure, comprising:
a substrate, comprising a signal line;
a pixel array, disposed on the substrate;
a first-stage shift register, disposed at a first side of the pixel array and coupled to the signal line for outputting a first-stage scan signal to the pixel array according to trigger of a first start pulse; and
a second-stage shift register, disposed at a second side of the pixel array and coupled to the signal line for receiving a second start pulse via the signal line.

2. The flat display structure according to claim 1, wherein the second start pulse is the first start pulse, the signal line is coupled to a start-pulse input terminal of the first-stage shift register and disposed in a region of the substrate outside the pixel array.

3. The flat display structure according to claim 1, wherein the second start pulse is the first-stage scan signal, the signal line is coupled to a scan-signal output terminal of the first-stage shift register and the signal line is a scan line coupled to the pixel array.

4. The flat display structure according to claim 1, wherein the second start pulse is the first-stage scan signal, the signal line is coupled a scan-signal output terminal of the first-stage shift register, and the signal line is disposed in a region of the substrate outside the pixel array.

5. The flat display structure according to claim 1, further comprising a third-stage shift register and a fourth-stage shift register, wherein the first-stage scan signal is used as a start pulse for the third-stage shift register and a second-stage scan signal outputted by the second-stage shift register is used as a start pulse for the fourth-stage shift register.

6. The flat display structure according to claim 1, wherein the first-stage shift register and the second-stage shift register are disposed on the substrate.

7. The flat display structure according to claim 1, is an amorphous silicone (a-Si) thin film transistor (TFT) liquid crystal display (LCD) structure.

8. A flat display structure, comprising:
a pixel array;
a first-stage shift register, disposed at a first side of the pixel array for outputting a first-stage scan signal to the pixel array according to a first clock signal and a second clock signal; and
a second-stage shift register, disposed at a second side of the pixel array for outputting a second-stage scan signal to the pixel array according to the second clock signal and a third clock signal;
wherein in a first timing stage, the first clock signal has a first voltage level, and the second clock signal and the third clock signal both have a second voltage level; in a second timing stage, the first clock signal and the third clock signal both have the second voltage level and the second clock signal has the first voltage level; in a third timing stage, the first clock signal and the second clock signal both have the second voltage level and the third clock signal has the first voltage level.

9. The flat display structure according to claim 8, wherein the first-stage shift register outputs the first-stage scan signal to the pixel array via a scan line and the second-stage shift register receives the first-stage scan signal as a start pulse via the scan line.

10. The flat display structure according to claim 8, further comprising a substrate for disposing the pixel array, wherein the substrate comprises a signal line disposed in a region outside the pixel array and coupled to the first-stage shift register and the second-stage shift register, and the first-stage shift register outputs the first-stage scan signal via the signal line as a start pulse for the second-stage shift register.

11. The flat display structure according to claim 8, further comprising a substrate for disposing the pixel array, wherein the substrate comprises a signal line disposed in a region outside the pixel array and coupled to the first-stage shift register and the second-stage shift register, and a start pulse of the first-stage shift register is outputted via the signal line as a start pulse for the second-stage shift register.

12. The flat display structure according to claim 8, further comprising a substrate for disposing the pixel array, wherein the first-stage shift register and the second-stage shift register are disposed on the substrate.

13. The flat display structure according to claim 8, further comprising a third-stage shift register and a fourth-stage shift register, wherein the first-stage scan signal is used as a start pulse for the third-stage shift register and the second-stage scan signal is used as a start pulse for the fourth-stage shift register.

14. The flat display structure according to claim 13, wherein the third-stage shift register outputs a third-stage scan signal to the pixel array according to the third clock signal and the first clock signal, and the fourth-stage shift register outputs a fourth-stage scan signal to the pixel array according to the first clock signal and the second clock signal.

15. The flat display structure according to claim 8, wherein the first voltage level is a high voltage level and the second voltage level is a low voltage level.

16. The flat display structure according to claim 8, wherein the first clock signal comprises a plurality of first timing intervals with the first voltage level, the second clock signal has a timing slower than the first clock signal by the first timing interval, and the third clock signal has a timing slower than the second clock signal by the first timing interval.

17. The flat display structure according to claim 8, is an a-Si TFT-LCD structure.
